(19) United States
(12) Patent Application Publication
(10) Pub. No.: US 2011/0222572 A1
(43) Pub. Date: Sep. 15, 2011

(54) LASER ARRANGEMENT

(75) Inventors: Gennadij Kusnezow, Langenhagen (DE); Andreas Boenke, Hannover (DE)

(73) Assignee: LPKF LASER & ELECTRONICS AG, Garbsen (DE)

(21) Appl. No.: 13/032,687

(22) Filed: Feb. 23, 2011

(30) Foreign Application Priority Data
Feb. 23, 2010 (DE) 10 2010 009 048

(51) Int. Cl. H01S 3/06; H01S 3/0941

(52) U.S. Cl. 372/66; 372/75

(57) ABSTRACT

A laser arrangement includes an optical resonator having a V arrangement of two resonator branches. At least one active medium includes an active volume associated with each resonator branch. The arrangement also includes folding element that is highly reflective for a fundamental wavelength of the laser arrangement and an optical pump imaging system configured to unidirectionally pump the two resonator branches. The optical pump imaging system includes a common objective lens for both resonator branches. The folding element is transparent for the pump wavelength.

### CROSS REFERENCE TO RELATED APPLICATIONS

This application claims priority to German Patent Application No. DE 10 2010 009 048, filed Feb. 23, 2010, which is hereby incorporated by reference herein in its entirety.

### FIELD

The invention relates to a laser arrangement, in particular a solid state laser, with at least one active medium in a resonator with two resonator branches each having one resonator mirror, said branches being pumped unidirectionally through a common objective lens by means of an optical system, the objective lens forming a folding element for a V arrangement of the resonator branches.

### BACKGROUND

In solid state lasers, the problem occurs that the active medium has a thermally induced refractive power for light which passes through. The pumping process results in a temperature increase in the medium, since only part of the absorbed pumping power is converted into usable radiation, and the rest is delivered to the material in the form of heat. Simultaneous cooling of the outer surfaces results in a temperature profile. Because of the temperature dependency of the index of refraction and the thermo-optical tension, this results in an index of refraction profile.

In principle, every thermal lens can be counteracted by suitable resonators. The possibility of grinding a concave end surface onto one or both ends of a laser rod, inserting a single negative lens into the resonator, or quite generally choosing a suitable resonator configuration, is generally known. Difficulties occur, in particular, in the search for suitable resonators for the whole range of pumping power from the laser threshold (which itself depends considerably on the chosen resonator) to the maximum pumping power.

Longitudinal excitation of diode-laser-pumped solid state lasers provides decisive advantages compared with transverse pumping. Radiation emitted by semiconductor lasers is coupled into the direction of the laser mode axis, or in the case of an amplifier into the direction of the oscillator beam, resulting in optimal overlapping of the pump beam volume with the mode volume or with the beam to be amplified in the amplifier. The optimal overlapping of the pump beam volume with the mode volume results in a higher efficiency. Additionally, an improved beam quality can be achieved, since only the fundamental laser mode is excited.

US 2005/0152426 A1 relates to a method of pumping a laser resonator with laser diodes, the longitudinal end surfaces of the resonator having specific optical properties. The wavelengths of the laser are not reflected by the end surfaces, and the wavelength of the pump beam is only partially reflected.

An element which is thermally coupled to a heat source, to compensate for deformation, caused by the laser beam, of the elements arranged in the beam path of the laser system is known, from WO 96/05637 A1.

EP 0 202 322 A1 discloses optical elements with suitable, temperature-dependent variation of the index of refraction and longitudinal extent, said elements being connected to a heat source so as to produce effects of the thermal lens and thermal double refraction in said elements in a targeted manner, to compensate for the thermal double refraction in solid state laser media.

DE 197 14 175 A1 relates to an optical element to compensate for the thermal lens in optically pumped solid state laser media. Compensation for the thermal lens is achieved by part of the pumped light itself being used, with its varying power, to create a corresponding optical element which compensates for the thermal lens in the active medium. This element should be either a modified coupling-in mirror or an additionally inserted element which acts as a lens with a negative (in the case of a negative thermal lens in the laser medium, positive) focal length.

A first variant relates to a special coupling-in mirror, which is produced from a substrate with suitable absorption for the pumped radiation and positive or negative coefficient of thermal expansion, and which because of the forming curvature of the mirror end surface acts as a convex or concave mirror for the resonator mode.

A second variant relates to a plate, preferably with an anti-reflection coating, and having a negative or positive thermal coefficient of the index of refraction and a suitable absorption for the pump wavelength and low losses for the laser wavelength.

DE 10 2007 023 298 A1 relates to diode-pumped lasers, in which pumped radiation with a first linear polarisation state is directed along a pump axis onto an amplifier medium. The laser axis can be an inner axis of a laser cavity or an axis along which laser radiation is emitted. The pump axis is folded to run along the laser axis as soon as the pumped radiation is received in the laser cavity.

U.S. Pat. No. 7,016,389 B2 relates to a laser with an active medium which is pumped from opposite sides.

### SUMMARY

An aspect of the invention is to simply achieve optimal beam quality and high power.

In an embodiment, the present invention provides a laser arrangement including an optical resonator having a V arrangement of two resonator branches. At least one active medium includes an active volume associated with each resonator branch. The arrangement also includes folding element that is highly reflective for a fundamental wavelength of the laser arrangement and an optical pump imaging system configured to unidirectionally pump the two resonator branches. The optical pump imaging system includes a common objective lens for both resonator branches. The folding element is transparent for the pump wavelength.

### BRIEF DESCRIPTION OF THE DRAWINGS

Exemplary embodiments of the present invention are described in more detail below with reference to the drawings, in which:

FIG. 1 shows an arrangement including an active medium, which is associated with resonator branches, and folding optics and a folding mirror with a planar outer surface;

FIG. 2 shows an arrangement including an active medium, which is associated with the resonator branches, and focusing optics and a curved folding mirror of an objective lens;

FIG. 3 shows an arrangement in which the reflector is implemented as a separate meniscus folding mirror;

FIG. 4 shows an arrangement including an with a deflecting element between focusing optics and an objective lens;

FIG. 5 shows an arrangement with a folding wedge between an optical waveguide and objective lens;

FIG. 6 shows an arrangement including an in which pump energy is fed in by two optical waveguides coupled into a common active medium;

FIG. 7 shows an arrangement in which the pump energy is fed in by a single optical waveguide coupled into a common active medium;

FIG. 8 shows an arrangement corresponding to FIG. 5, with two V arrangements which are arranged in a common plane, with a total of four resonator branches;

FIG. 9 shows an arrangement with four optical waveguides which couple the pump energy into a common objective lens; and

FIG. 10 shows an arrangement with a non-linear module in a resonator branch.

### DETAILED DESCRIPTION

In an embodiment, the present invention provides a laser arrangement that includes an active medium in a resonator which includes two resonator branches each having one resonator mirror, said branches being pumped unidirectionally through a common objective lens by means of an optical system, the objective lens forming a folding element for a V arrangement of the resonator branches. The invention is based, in part, on the finding that the power can easily be increased and the beam quality of the laser can be improved if the folding of the resonator is implemented with only one element, the objective lens, into which the pump energy is jointly coupled, an active volume being arranged for each resonator branch. In this way, a structure which is simple to implement and manages with a comparatively small number of components is created. The pump energy can be fed in by means of optical waveguides from a common side, without the optical waveguides having to be greatly bent for this purpose. The folding element is highly transmissive for the wavelength of the pump energy, and highly reflective for the fundamental wavelength. The folding element can also be implemented as a planar mirror, for example. Because of the minimal number of optical components, the losses which occur in practice are also minimised. The active volume associated with each resonator branch is preferably positioned and aligned centrally and coaxially with the optical axes of that resonator branch. In particular, the active volumes are spatially separated. Overlapping or an overlapping region of the active volumes of the resonator branches is avoided. With the greatest possible overlap of the active volumes and the resonator mode which is formed, higher efficiency is achieved.

A particularly advantageous embodiment is also achieved by the reflector having a spherically curved surface. The reduction of the common optical power of the thermal lens is caused by the outer surface, which acts as a convex folding mirror, of the objective lens, which forms the coupling-in element and couples in the pumping power.

A further, particularly advantageous version of the present invention is also achieved by at least one active medium having a spherical face. In this way the strong positive thermal lens which occurs because of the power density of the pumping power is compensated for in the region of the thermal lens which occurs. For this purpose, the thermal lens is compensated for by the for example concavely curved end face or face of the active medium, which acts as a negative thermal lens.

If, according to a particularly practical modification of the invention, the reflector is formed by an outer face of focusing optics of the objective lens, the number of required optical components can be further reduced by the reflector being formed by the surface of the focusing lens facing the resonator branches.

Furthermore, it is advantageous if the reflector is implemented as a separate folding mirror, in particular as a meniscus folding mirror, to achieve separation of functions, e.g. for independent adjustment of the system which images the pumping power on the one hand, and of the convex folding element on the other hand.

It is advantageous to keep the folding angle as small as possible, and thus avoid astigmatism. The resonator branches are arranged so that the folding angle enclosed between them is in particular about 4°.

The pumping power is fed in by means of separate optical waveguides. Additional focusing and/or collimation optics of the optical pump imaging system can be associated with each optical waveguide.

It is also particularly promising if the laser has at least one deflecting element which is arranged between the focusing optics and the objective lens, in particular including a deflecting mirror and/or a prism. In this way a small folding angle of the resonator branches can be implemented, to avoid astigmatism, without this also resulting in a structurally resource-intensive and/or disadvantageous arrangement of the optical systems when the pumping power is fed in. The optical systems would otherwise, corresponding to the large diameters of the fibre collimators or of the fibre imaging optics, have to be arranged at a great distance from the coupling-in element formed by the objective lens. The deflection at the deflecting element, preferably a deflecting mirror or prism which can be positioned adjacently to the axis of symmetry determined by the resonator branches, thus makes a compact embodiment possible.

Similarly, the desired effect can also be achieved by the deflecting element being implemented in a transmissive form, in particular as at least one folding wedge, so as to achieve the desired deflection.

Preferably, the imaging plane for imaging intermediate images is close to the axis of symmetry, to make the small folding angle possible. For this purpose, the deflection can take place in the region in which the pump beams are spatially separated.

It is also particularly advantageous if the pumping power is fed in by means of parallel optical waveguides, in particular using faces of the optical waveguides arranged in a plane, and the optical system has telecentric imaging optics, because in this way particularly compact construction and further simplification of the optical system can be achieved.

The laser arrangement according to the invention can of course be implemented with one active medium in each resonator branch. On the other hand, a further simplified embodiment is also achieved by the pump energy which is fed in by means of separate optical waveguides being coupled into a common active medium. By using only one common active medium, it becomes possible to reduce further its distance from the reflector which acts as a folding mirror, and the overall size of the optical system.

Alternatively, according to a further particularly practical modification, the optical system can be configured for dividing the pump energy which is fed in by means of an optical waveguide into two sub-beams.

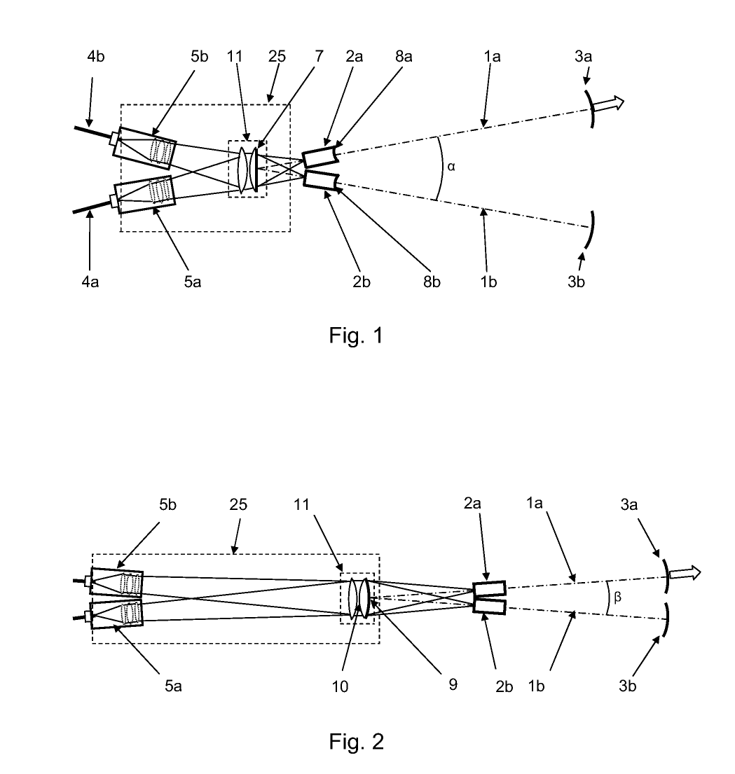

FIG. 1 shows a laser arrangement such as can be used, in particular, in a solid state laser. The laser arrangement has a folded resonator with a folding angle α between the resonator branches 1a, 1b, each of which has an active medium 2a, 2b and a resonator mirror 3a, 3b. The pumping power which is fed in by means of separate optical waveguides 4a, 4b is pumped unidirectionally by means of collimation optics 5a, 5b through an objective lens 11, which has a folding element 7 with a planar outer surface. The two sets of collimation optics 5a, 5b, together with the objective lens 11, form a pump imaging system 25. The two active media 2a, 2b each have a spherical face 8a, 8b facing the associated resonator mirror 3a, 3b, so as to compensate as required for the thermal lens which occurs in the active media.

In contrast, in the variant shown in FIG. 2, the folding element is executed as a spherically curved folding element 9 of a lens 10 of the objective lens 11, through which the resonator branches 1a, 1b are pumped unidirectionally by means of the two separate sets of collimation optics 5a, 5b. The two sets of collimation optics 5a, 5b, together with the objective lens 11, form the pump imaging system 25. The curved outer face 9 of the lens 10 is correspondingly highly transmissive for the pump wavelength and highly reflective for the fundamental wavelength of the laser, and can be implemented, for example, by a suitable coating of the lens 10. Because of the thermal lens compensation which can be achieved by means of the curved folding element 9, in contrast to the variant shown in FIG. 1, a concave formation of the faces of the two active media can be omitted in favour of a purely planar property of the faces. With a small folding angle β of about 4°, it is possible to make the astigmatism practically unnoticeable. However, purely structurally, this variant results in a comparatively large distance of the collimation optics 5a, 5b from the objective lens 11.

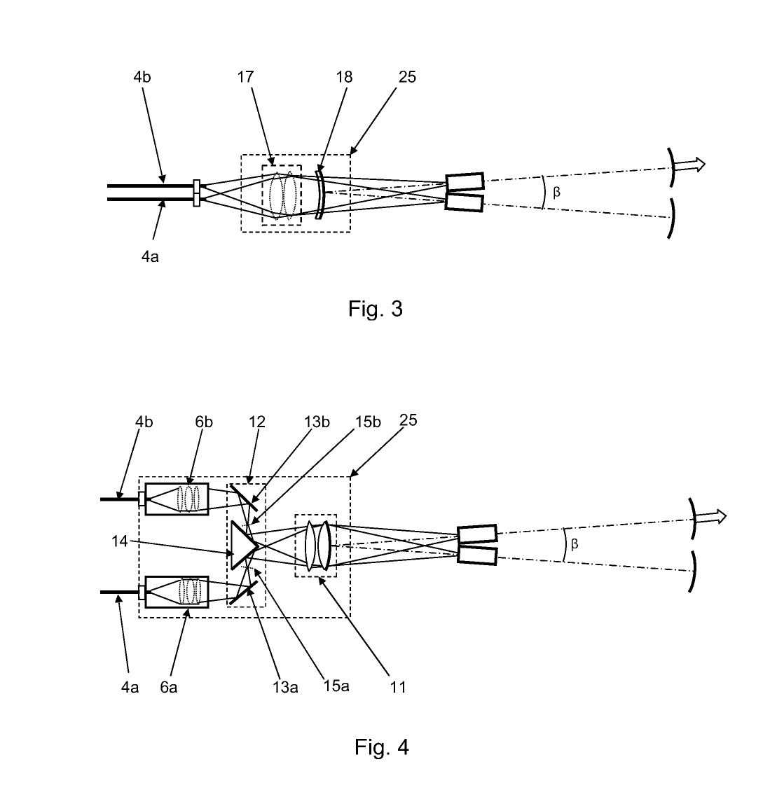

FIG. 3 shows a variant in which the folding element is executed as a separate meniscus mirror 18, and together with the objective lens 17 arranged in a pump imaging system 25. The optical waveguides 4a, 4b for feeding in the pumping power are arranged in parallel in front of the objective lens 17.

To reduce the overall length, in the variant shown in FIG. 4, between the focusing optics 6a, 6b and the objective lens 11, in each case double deflection is provided by means of a deflecting element 12, which on the one hand has a separate deflecting mirror 13a, 13 which is associated with one of the sets of focusing optics, and on the other hand has a common prism 14 as the carrier of the two mirrors which are attached on the cathetus sides. In this way, a small folding angle β of the resonator branches can be implemented, with an also small distance of a fibre end of the optical waveguide 4a, 4b of the relevant focusing optics 6a, 6b from the objective lens 11. An imaging plane 15a, 15b of the fibre ends can be in the beam path after the deflecting mirror 13a, 13b and before the further deflection at the prism 14. The pump imaging system 25 receives the two sets of focusing optics 6a, 6b, the deflecting element 12 and the objective lens 11.

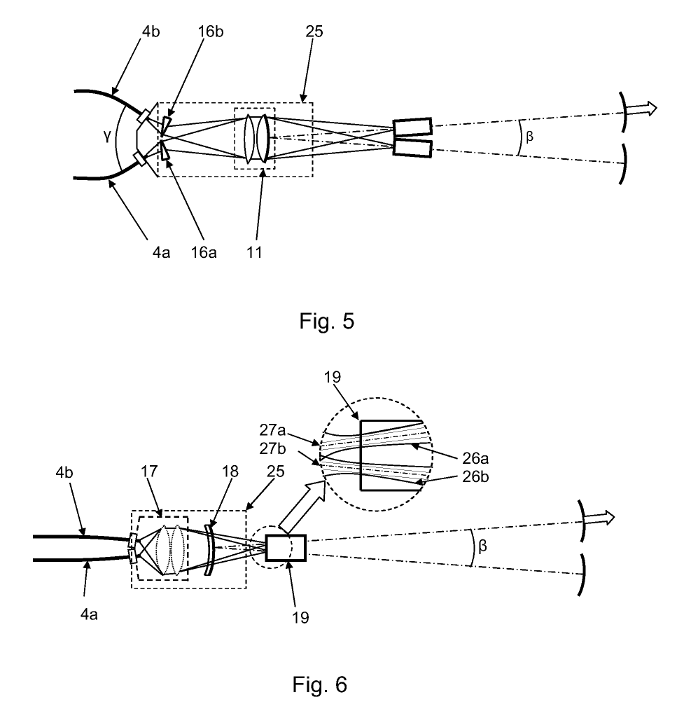

According to the variant shown in FIG. 5, a similar shortening of the overall length results from the arrangement of a transmissive deflecting element in the form of a folding wedge 16a, 16b between the optical waveguide 4a, 4b and the objective lens 11 in each case, so as to achieve a greater angle γ enclosed between the fibres, thus permitting positioning closer to the objective lens 11.

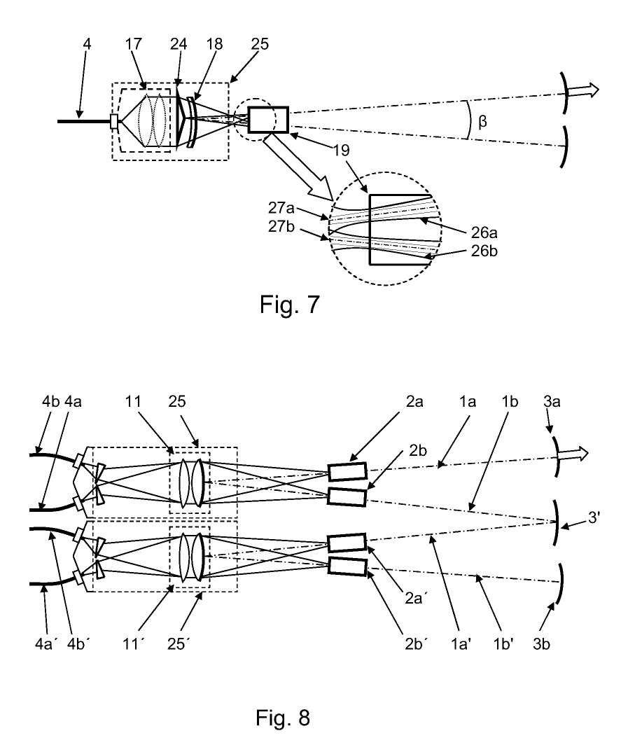

A modification which is simplified further than these is shown in FIGS. 6 and 7. With a folding angle β of the resonator branches 1a, 1b which in itself is unchanged or only slightly different, only a common active medium 19 with two active volumes 26a, 26b is used. Into these active volumes 26a, 26b, the pumping power which is fed in by means of the optical waveguides 4, 4a, 4b is coupled in by the folding element, which is executed as a meniscus folding mirror 18, centrally and coaxially with the optical axis 27a, 27b of the relevant resonator branch 1a, 1b. The optical waveguides 4a, 4b open into a common objective lens 17, which together with the meniscus folding mirror 18 forms the pump imaging system 25. As can be seen, in this way a further reduced overall length of the laser arrangement can be achieved, and also the number of components required for this purpose can be reduced.

Additionally, in FIG. 7 a splitting prism 24 is arranged between the objective lens 17 and the meniscus folding mirror 18, so that the pump energy can be fed in by means of only a single optical waveguide 4.

FIG. 8 shows a variant which is constructed according to the principle shown in FIG. 5, but in which doubling of the elements is provided. The pump energy which is fed in by means of four separate optical waveguides 4a, 4b, 4a′, 4b′ running in a common plane is fed to two pump imaging systems 25, 25′, each of which encloses an objective lens 11, 11′. In each of the four resonator branches 1a, 1a′, 1b, 1b′ arranged in a common plane, an active medium 2a, 2b, 2a′, 2b′ is arranged, a resonator mirror 3a, 3b being associated with the resonator branches 1a and 1b′, and an additional folding mirror 3′ being associated with both the resonator branch 1b and the resonator branch 1a′.

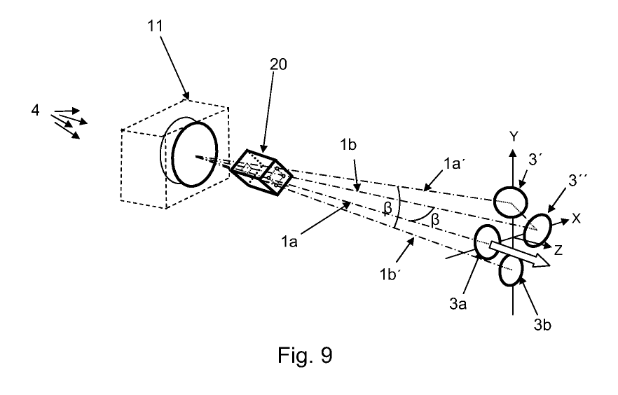

FIG. 9 additionally shows another variant, in which the pump energy is coupled by four optical waveguides 4 into a common objective lens 11, similarly to the shown variants. The pump energy then enters a common active medium 20, which has four active volumes. In this variant, the resonator branches are arranged in two planes X, Y running perpendicularly to each other (Z is the resonator axis of symmetry), a resonator mirror 3a, 3b or an additional folding mirror 3′, 3″ being associated with each resonator branch.

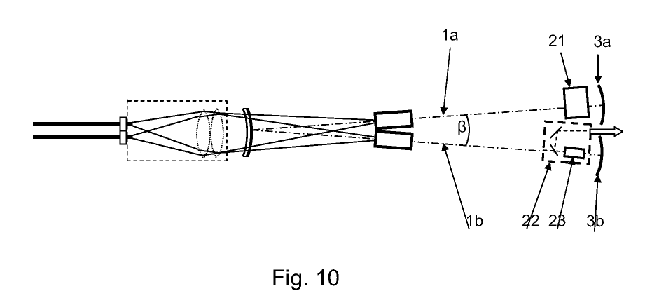

FIG. 10 shows a variant of the embodiment shown in FIG. 3. In its first resonator branch 1a, an optional Q-switch 21 is provided, and in its second resonator branch 1b, at least one module 22 with at least one non-linear element 23 for generating a higher harmonic in the resonator is provided.

While the invention has been particularly shown and described with reference to preferred embodiments thereof, it will be understood by those skilled in the art that various changes in form and details may be made therein without departing from the spirit and scope of the invention.

What is claimed is:

1. A laser arrangement comprising:
an optical resonator including a V arrangement of two resonator branches
at least one active medium including an active volume associated with each resonator branch;
a folding element that is highly reflective for a fundamental wavelength of the laser arrangement;
an optical pump imaging system configured to unidirectionally pump the two resonator branches and including a common objective lens, the folding element being transparent for the pump wavelength.

2. The laser arrangement recited in claim 1, wherein the laser arrangement forms a part of a longitudinally diode-pumped solid state laser.

3. The laser arrangement recited in claim 1, wherein each resonator branch includes an active medium of the at least one active medium.

4. The laser arrangement recited in claim 3, wherein each active medium includes a concave face, and wherein the folding element has a planar form.

5. The laser arrangement recited in claim 1, wherein each of the at least one active medium includes planar faces, and wherein the folding element includes a spherical form.

6. The laser arrangement recited in claim 1, wherein the folding element is formed as a highly reflective surface of an outside of the objective lens.

7. The laser arrangement recited in claim 1, wherein the folding element includes a mirror.

8. The laser arrangement recited in claim 7, wherein the mirror is a meniscus mirror.

9. The laser arrangement recited in claim 1, wherein the optical pump imaging system includes at least one set of collimation optics.

10. The laser arrangement recited in claim 1, wherein the optical pump imaging system includes at least one set of focusing optics configured to generate an intermediate image.

11. The laser arrangement recited in claim 1, further comprising separate optical waveguides corresponding to each resonator branch and configured to feed in pumping power.

12. The laser arrangement recited in claim 1, wherein the optical pump imaging system includes at least one deflecting element.

13. The laser arrangement recited in claim 1, further comprising parallel optical waveguides corresponding to each resonator branch and configured to feed in pumping power, and wherein the objective lens includes an object-side telecentric imaging optics.

14. The laser arrangement recited in claim 1, wherein the optical pump imaging system includes a splitting prism configured to divide pumped radiation from an optical waveguide into two sub-beams.

15. The laser arrangement recited in claim 1, further comprising at least one additional V arrangement that is optically coupled with an additional folding element.

16. The laser arrangement recited in claim 1, wherein the V arrangement is oriented in a first plane, and further comprising an additional V arrangement oriented in a second plane, the V arrangement and additional V arrangement being optically coupled by folding mirrors, and wherein the objective lens is common to both V arrangements.

17. The laser arrangement recited in claim 16, wherein the first and second planes are perpendicular.

18. The laser arrangement recited in claim 1, further comprising a Q-switch modulator disposed in one of the resonator branches and configured to generate pulsed laser radiation.

19. The laser arrangement recited in claim 1, further comprising at least one module including at least one non-linear element disposed in at least one of the resonator branches, and configured to generate at least one higher harmonic.

20. The laser arrangement recited in claim 1, wherein the active volume associated with each resonator branch is disposed centrally and coaxially with an optical axis of the respective resonator branch.
